(19) United States
(12) Patent Application Publication
(10) Pub. No.: US 2004/0086684 A1
(43) Pub. Date: May 6, 2004

(54) Moisture-permeable, waterproof and windproof laminated sheet, interlining using the same, and garment containing the interlining

(76) Inventors: Hiroko Suzuki, Tokyo (JP); Takahiro Tanino, Okayama-ken (JP)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/602,216

(22) Filed: Jun. 24, 2003

Related U.S. Application Data
(60) Provisional application No. 60/391,884, filed on Jun. 26, 2002.

(51) Int. Cl. B32B 5/00; B32B 5/14; B32B 27/12

(52) U.S. Cl. 428/98; 428/171; 428/297.4

(57) ABSTRACT

A laminated sheet made by bonding a nonwoven fabric to a non-porous waterproof, windproof and moisture permeable film. The bonding may be carried out by hot pressing in combination with a hot-melt adhesive and the laminated sheet may have a water vapor transmission rate of 1,000 to 10,000 g/m²·h. The laminated sheet may be further bonded to a face fabric, making the resulting structure particularly suitable for use in the construction of garments.

### CROSS REFERENCE TO RELATED APPLICATION

The present application for patent claims the benefit of the filing date for U.S. provisional patent application serial No. 60/391,884, filed on Jun. 26, 2002.

### FIELD OF THE INVENTION

The present invention relates to a laminated sheet produced by laminating a nonwoven fabric with a nonporous film that is waterproof, windproof and moisture permeable. The invention relates in particular to a moisture-permeable, waterproof and windproof laminated sheet which is highly suitable for use in such applications as textile interlinings, to interlinings containing such laminated sheets, and to garments or fabrics having such interlinings.

### BACKGROUND OF THE INVENTION

As users have become increasingly diverse and developed a more discriminating attitude toward merchandise, they have come to expect today's garments to be endowed with various advanced capabilities depending on the particular application. For example, in the case of sportswear and work clothes that are worn outdoors, people dislike the unpleasantness of having perspiration linger on the skin, yet at the same time expect the garment to be windproof to shield the body from the cold outside air. In response to such consumer needs, there has arisen a desire to provide outdoor clothing which allows moisture such as perspiration to pass through yet has the ability to shut out the flow of outside air.

Garments and fabrics designed for this purpose which have appeared on the market include those having a construction composed of a porous polyurethane or fluorocarbon resin film inserted between two layers of surface fabric. U.S. Pat. No. 4,761,324 discloses a waterproof, moisture-permeable woven fabric produced by using a polyurethane adhesive to bond and laminate a nonwoven fabric with a porous polyurethane film. Although this product does satisfy the above functional requirements, it already has a single fixed form and so cannot be used in combination with a wide range of commercially available fabrics to impart moisture permeable, waterproof and windproof qualities.

JP-A 63-235509 describes a garment interlining which is a laminate of a polyurethane elastomeric fiber nonwoven fabric with a woven fabric, to either surface of which has been applied a hot melt-type point adhesive.

JP-B 62-263 relates to an interlining used in clothing. In particular, it discloses an interlining composed of a nonwoven fabric produced by laminating a monodirectional web with a non-directional web, wherein an iron-bondable adhesive has been applied to the surface of the nonwoven fabric on the monodirectional web side thereof and an inter-fiber binder has been locally applied in a discontinuous pattern to the non-directional web side of the fabric.

JP-A 9-187897 describes a moisture-permeable, waterproof laminate produced by laminating a substantially nonporous film composed of a thermoplastic resin with a nonwoven fabric, which laminate has a water vapor transmission rate of at least 1,000 g/m²·day and a water pressure resistance of at least 500 mm.

JP-B 6-41195 describes a laminate composed of a porous polyolefin resin sheet and a nonwoven fabric made of two types of fiber so as to enable it to heat fuse to the polyolefin resin sheet at a low temperature, one type of fiber having a polypropylene core and an ethylene-vinyl acetate copolymer sheath and the other type being a low-density polyethylene.

JP-A 9-105059 discloses an inner material for firefighting wear, in which the moisture-permeable waterproof base material is a nonwoven fabric made of a moisture-permeable waterproof film and polyester fibers.

U.S. Pat. No. 4,493,870 discloses a flexible laminate composed of a fabric covered with a waterproof, moisture-permeable polyetherester film.

In spite of the above art, there exists in fact a desire among fabric processors such as sewing companies for materials which can be laminated with various types of fabric and thereby used to develop combination products endowed with distinctive moisture-permeable, waterproof and windproof capabilities. There is also a desire for combination products in which such combination provides composite characteristics which fully satisfy the requirements for fabric interlinings without compromising the characteristic features of the component materials. In addition, fabric processors have a strong desire for composite materials conducive to flexible manufacturing that can easily be employed without requiring large-scale press machinery and can be used to turn out products in small lots. No composite materials that meet these requirements have previously been known.

It is therefore one object of the present invention to provide combination sheet materials which have a moisture permeability and also waterproof and windproof properties that satisfy the properties required of interlinings, which can be laminated with another fabric or some other base material using a simple hot press, and which are capable of imparting the fabric or base material with moisture permeability, windproof and waterproof capabilities. Another object of the invention is to provide interlinings that use such combination materials. A still further object is to provide garments and fabrics containing such interlinings.

### SUMMARY OF THE INVENTION

The inventors have conducted extensive investigations in order to resolve such problems. As a result, they have found that a laminate having a two-layer construction composed of at least a nonwoven fabric and a specific nonporous, waterproof, windproof and moisture-permeable film arrived at by bonding and laminating the nonwoven fabric with the film, or having a three-layer construction in which the above nonwoven fabric and film have been combined with an adhesive layer therebetween, is able to confer moisture-permeable, windproof and waterproof capabilities when laminated with another fabric or some other base material using a commonly employed method.

Accordingly, the invention provides the following.

(1) A laminated sheet made of a laminate produced by bonding and laminating a nonwoven fabric with a nonporous waterproof and windproof moisture-permeable film.

(2) The laminated sheet of (1) above, wherein the nonwoven fabric in the laminate has an adhesive layer dispersed and coated over substantially the entire surface thereof.

(3) The laminated sheet of (1) or (2) above, wherein the laminate has a water vapor transmission rate (“WVTR”), as measured by method A-1 described in section 4.1.1 of JIS L-1099, of 1,000 to 20,000 g/m²·24 h; an air permeability, as measured according to JIS L-1018, of up to 30 cm³/cm²/s; and a water pressure resistance, as measured according to JIS L-1092, of 100 to 40,000 mm.

(4) A laminated sheet according to any one of (1) to (3) above, wherein the film is hydrophilic.

(5) The laminated sheet according to any one of (1) to (4) above, wherein the film is made of a polyesterether elastomer.

(6) The laminated sheet according to any one of (1) to (5) above, wherein the film is made of a polyesterether elastomer prepared by ester linkages between long-chain ester repeating units of formula (I) below and short-chain ester repeating units of formula (II) below.

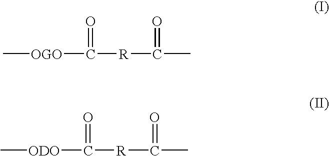

wherein:

a) G is a divalent radical remaining after the removal of terminal hydroxyl groups from a poly(alkylene oxide)glycol having a number average molecular weight of about 400-4000;

b) R is a divalent radical remaining after removal of carboxyl groups from a dicarboxylic acid having a molecular weight less than 300;

c) D is a divalent radical remaining after removal of hydroxyl groups from a diol having a molecular weight less than about 250; optionally

d) the copolyetherester contains 0-68 weight percent based on the total weight of the copolyetherester, ethylene oxide groups incorporated in the long-chain ester units of the copolyetherester; and

e) the copolyetherester contains about 25-80 weight percent short-chain ester units.

(7) The laminated sheet of any one of (1) to (6) above, wherein the laminate is produced by bonding the nonwoven fabric and the film with a hot-melt adhesive.

(8) The laminated sheet of any one of (5) to (7) above, wherein the nonwoven fabric is made with polyester fibers and the hot melt adhesive is composed primarily of a polyester resin.

(9) An interlining which contains the laminated sheet of any one of (1) to (8) above.

(10) A garment or fabric which uses the interlining of (9) above.

### DETAILED DESCRIPTION OF THE INVENTION

The invention thus provides laminated sheets produced by combining a nonwoven fabric with a moisture-permeable, waterproof and windproof film; interlinings in which such laminated sheets are used; and garments or fabrics produced by laminating such interlinings with face fabrics.

The nonporous, waterproof, windproof moisture-permeable film used in the invention must be hydrophilic. Because of the film's hydrophilic properties, moisture adhering to the surface of such a film can permeate to and diffuse through the interior of the film, making it possible to release water vapor from the back face of the film where the water vapor concentration is low. Various hydrophilic polymers can be used as the film having such properties.

As used herein, the term “Hydrophilic polymers” means polymers which absorb water when in contact with liquid water at room temperature according to the International Standards Organization specification ISO 62 (equivalent to the American Society for Testing and Materials specification ASTM D 570).

The hydrophilic polymer suitable for preparing the hydrophilic non-porous membranes for use in the present invention can be one or a blend of several polymers, for example, the hydrophilic polymer can be a copolyetherester elastomer or a mixture of two or more copolyetherester elastomers as described below, such as polymers available from E I du Pont de Nemours and Company under the trade name Hytrel®; or a polyether-block-polyamide, or a mixture of two or more polyether-block-polyamides, such as polymers available from the Elf-Atochem Company of Paris, France under the trade name of PEBAX; or a polyether urethane or a mixture of polyether urethanes; or homopolymers or copolymers of polyvinyl alcohol or a mixture of homopolymers or copolymers of polyvinyl alcohol.

A particularly preferred polymer for water vapor transmission in this invention is a copolyetherester elastomer or mixture of two or more copolyetherester elastomers having a multiplicity of recurring long-chain ester units and short-chain ester units joined head-to-tail through ester linkages, where the long-chain ester units are represented by the formula:

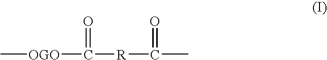

and said short-chain ester units are represented by the formula:

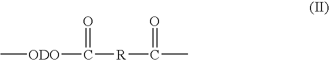

wherein:

a) G is a divalent radical remaining after the removal of terminal hydroxyl groups from a poly(alkylene oxide)glycol having a number average molecular weight of about 400-4000;

b) R is a divalent radical remaining after removal of carboxyl groups from a dicarboxylic acid having a molecular weight less than 300;

c) D is a divalent radical remaining after removal of hydroxyl groups from a diol having a molecular weight less than about 250; optionally

d) the copolyetherester contains 0-68 weight percent based on the total weight of the copolyetherester, ethylene oxide groups incorporated in the long-chain ester units of the copolyetherester; and

e) the copolyetherester contains about 25-80 weight percent short-chain ester units.

This preferred polymer is suitable for fabricating into thin but strong membranes, films and coatings. The preferred polymer, copolyetherester elastomer and methods of making it are known in the art, such as are disclosed in U.S. Pat. No. 4,725,481 for a copolyetherester elastomer with a WVTR of at least 3500 g/m²/24 hr, or U.S. Pat. No. 4,769,273 for a copolyetherester elastomer with a WVTR of 400-2500 g/m²/24 hr. Both are incorporated herein by reference in their entirety.

The polymer can be compounded with antioxidant stabilizers, ultraviolet stabilizers, hydrolysis stabilizers, dyes or pigments, fillers, anti-microbial reagents and the like.

The use of commercially available hydrophilic polymers as membranes is possible in the context of the present invention, although it is more preferable to use copolyetherester elastomers having a WVTR of more than 400 g/m²/24 hr measured on a film of thickness 25 microns using air at 23° C. and 50% relative humidity at a velocity of 3 m/s. Most preferred is the use of membranes made from commercially available copolyetherester elastomers having a WVTR of more than 3500 g/m²/24 hr, measured on a film of thickness 25 microns using air at 23° C. and 50% relative humidity at a velocity of 3 m/s.

The hydrophilic polymers can be manufactured into membranes of any desired thickness by a number of processes. A useful and well-established way to make membranes in the form of films is by melt extrusion of the polymer on a commercial extrusion line. Briefly, this entails heating the polymer to a temperature above the melting point, extruding it through a flat or annular die and then casting a film using a roller system or blowing a film from the melt

The term ‘waterproof,’ as used herein, refers to a water pressure resistance, as measured by the method set forth in JIS L-1092 (Methods for Testing the Water Resistance of Textiles), of at least 100 mm. A water pressure resistance of at least 2,000 mm is preferred.

“Moisture-permeable,” as used herein, refers to a water vapor transmission rate, as measured by method A-1 described in section 4.1.1 of JIS L-1099 (Methods for Measuring the Water Vapor Permeability of Textiles”), of 1,000 to 10,000 g/m²·24 h. A water vapor transmission rate of 3,000 to 20,000 g/m²·24 h is preferred.

“Windproof,” as used herein, refers to an air permeability, as measured according to JIS L-1018 (Frazier Tester), of up to 30 cm³/cm²/s.

The nonporous waterproof, windproof, moisture-permeable film has a thickness of preferably 5 to 50 μm, and most preferably 5 to 20 μm. At a thickness greater than 50 μm, the flexibility of the film when used in a laminated sheet declines, lowering the feel and processability of the interlining. On the other hand, at a thickness of less than 5 μm, the film tends to damage easily, such as by puncturing or breakage.

The nonwoven fabric used in the invention is not subject to any particular limitation, and may be one having a construction, material composition and basis weight suitable for the particular application. For example, if the product is to be used as a textile interlining, use may be made of any nonwoven fabric that has hitherto been employed in interlinings. Illustrative constructions include thermally bonded product, chemically bonded product, hydroentangled product, and raschel-type, nonwoven composite fabric combinations. Preferred examples of the material making up the nonwoven fabric include polyester, nylon, rayon, cotton, and acrylic. The basis weight is preferably 10 to 100 g/m², and most preferably 10 to 30 g.m².

The laminated sheets of the invention obtained by combining the above-described nonwoven fabric and the above-described film can be produced by a known method. Common methods include point bonding, full-surface bonding, ultrasonic bonding and heat bonding. A laminated sheet having the above-described two-layer or three-layer construction which constitutes the combination laminated sheet of the invention can be produced by a suitable process selected from among these ordinary techniques. A bonding process which uses a hot melt adhesive is especially preferred because it does not compromise the inherent properties of the nonwoven fabric and the water-proof, windproof, moisture-permeable film.

The process of combining the nonwoven fabric with the waterproof, windproof moisture-permeable film, referred to hereinafter as “step A,” can easily be achieved by layering the nonwoven fabric, to one or both sides of which a hot-melt adhesive has been attached, with the waterproof, windproof, moisture-permeable film and hot pressing the fabric and film in this state. The hot-melt resin used for this purpose is one which, obviously, is capable of exhibiting bonding capabilities within a temperature range where the inherent capabilities of the waterproof, windproof, moisture-permeable film are not compromised.

The hot-melt resin in the laminated sheet of the invention may be any resin which melts and exhibits bonding capabilities at 100 to 150° C., and preferably 120 to 150° C. Illustrative examples include polyester resins, polyamide resins, polyolefin resins and polyurethane resins. Polyester resins are especially preferred.

The nonwoven fabric/waterproof, windproof, moisture-resistance film laminated sheet obtained in step A then has a hot-melt adhesive applied to one side thereof: on the waterproof, windproof, moisture-resistant film (adhesion step B). The hot-melt adhesive is preferably applied over less than the full surface. Application over less than the full surface means that the hot-melt adhesive is present on only part of the surface, leaving a portion of the moisture-permeable film exposed. Such a hot-melt adhesive layer may be in the form of, for example, net-like, dotted, or webbed pattern. By laminating the hot-melt adhesive so it covers less than the full surface, a marked decline in the moisture permeability of the laminated sheet as a whole is avoided.

Production of the laminated sheet of the invention may be carried out in the following way. The nonwoven fabric bearing a hot melt resin is layered with the waterproof, windproof, moisture-permeable film so that the hot melt resin-bearing face of the fabric is on the film side, following which hot pressing is carried out at a temperature which is at least high enough for the hot-melt resin to act as an adhesive but not so high as to compromise the moisture permeability of the waterproof, windproof, moisture-permeable film. This yields a composite of the nonwoven fabric and the waterproof, windproof, moisture-permeable film.

Next, a layer of the hot-melt adhesive is applied to the waterproof, windproof, moisture-permeable film side of this composite. This can easily be done by applying the hot-melt adhesive in a dotted pattern with a “dot processor” and curing.

Alternatively, the laminated sheet may be produced using an ultrasonic bonding process which ultrasonic energy to melt and fuse the various materials, such as nonwoven fabric, manmade fiber fabric and film. The application of ultrasonic energy causes the above materials to immediately melt and bond (bonding step A). Because an adhesive is not used, bonding can be achieved without a loss in the moisture permeability of the moisture-permeable film. Accordingly, this is an effective bonding method for applications in which a high peel strength is not required but a good moisture permeability is desired.

For example, laminated sheets according to the invention which are obtained by means of bonding step B, when laminated with any of various base materials, such as a fabric, are able to confer the base material with moisture permeability, windproof properties, and also waterproof properties. Composite sheets obtained by above bonding step A are advantageous as moisture-permeable and windproof interlinings for fabrics and garments, and may be widely used in hats, shoes, gloves and other applications.

### EXAMPLES

Examples are given below by way of illustration, although the invention is not limited by the examples.

### Example 1

A polyester copolymer hot-melt resin (Platherm®, manufactured by Atofina Chemical, Inc.) was applied as a layer of dots (9 g/m²) onto one side of a thermal bonded nonwoven fabric (nylon/polyester, manufactured by Kurabo Industries, Ltd. under the trade name KURANBON) having a basis weight of 16 g/m². Next, a waterproof, windproof, moisture-permeable polyesterether elastomer film available from E I du Pont de Nemours and Company under the trade name Hytrel® active membrane (thickness, 12 μm; water vapor transmission rate, 6,200 g/m²·24 h) was layered thereon and hot-pressing was carried out with a roller press (Asahi JR1800), thereby effecting bonding and lamination by the hot melt resin. The same polyester copolymer hot melt resin as above was then applied as a layer of dots onto the waterproof, windproof, moisture-permeable film side of the two-layer sheet, yielding a laminated sheet according to the invention.

The laminated sheet produced as described above was laminated onto a circuit-knit fabric (TENJIKU, 100% cotton made by Kurabo Industries, Ltd.) using a roller press, thereby producing a fabric in which the face fabric was imparted with windproof properties while retaining moisture permeability. The moisture permeability and air permeability of the fabric and laminated sheet were measured by the subsequently described methods. Those results and the performance of the polyester fleece alone prior to combination with the laminated sheet are shown in Table 1 in order to illustrate the change in properties due to the combination of materials.

### Example 2

A polyester copolymer hot-melt resin (manufactured by EMS-Showa Denko under the trade name GRILTEX) powder was laminated in an amount of 10 g/m² by a sintering process onto one side of a thermal-bonded polyester nonwoven fabric (manufactured by Kurabo Industries, Ltd. under the trade name KURANBON) having a basis weight of 16 g/m². Next, a waterproof, windproof, moisture-permeable polyesterether elastomer film available from E I du Pont de Nemours and Company under the trade name Hytrel® active membrane (thickness, 12 μm; water vapor transmission rate, 6,200 g/m²·24 h) was layered thereon and hot-pressing was carried out with a roller press (Asahi JR1800), thereby effecting bonding and lamination by the hot melt resin. The same polyester copolymer hot melt resin as above was then applied as a layer of dots onto the waterproof, windproof, moisture-permeable film side of the two-layer sheet, yielding a laminated sheet according to the invention. Measurement results for the moisture permeability and air permeability of the laminated sheet are shown in Table 1.

### Comparative Example 1

A laminated sheet was produced by laminating a urethane film on the resin-free side of a thermal-bonded nonwoven fabric (nylon/polyester) bearing on one side thereof 9 g/m² of polyester copolymer hot-melt resin (Platherm®, manufactured by Atofina Chemicals, Inc.) in a dotted pattern.

TABLE 1

| | Water vapor | | | Air | | | Water pressure | | |
|---|---|---|---|---|---|---|---|---|---|
| | transmission rate | | | permeability | | | resistance | | |
| | (g/m² · 24 h) | | | (cm³/cm²/s) | | | (kPa) | | |
| | EX | EX | Comparative | EX | EX | Comparative | EX | EX | Comparative |
| | 1 | 2 | EX1 | 1 | 2 | EX1 | 1 | 2 | EX1 |
| Film only | 6200 | 6200 | — | <0.87 | <0.87 | — | — | — | — |
| Laminated sheet | 4476 | 4650 | 480 | <0.87 | <0.87 | <0.87 | — | — | — |
| Face fabric/ | 4552 | — | 1174500 | <0.87 | — | <0.87 | 110 | — | — |
| laminated sheet | | | | | | | | | |
| combination | | | | | | | | | |
| Face sheet alone | 9622 | — | — | 87.9 | — | — | 0 | — | — |

The water vapor transmission rate, air permeability and water pressure resistance of the laminated sheets and fabrics were measured as follows in the above examples.

Water Vapor Transmission Rate:

Measured by the calcium chloride method (method A-1) in section 4.1.1 of JIS L-1099 (Methods for Measuring the Water Vapor Permeability of Textiles”).

Air Permeability:

Measured in accordance with “Air permeability (Frazier tester)” in JIS L-1018.

Water Pressure Resistance:

Measured in accordance with method B (High Water Pressure Method) in section 6.1 of JIS L-1092 (Methods for Testing the Water Resistance of Textiles).

The waterproof, windproof, moisture-permeable laminated sheet of the invention obtained by combining a nonwoven fabric (with a waterproof, windproof, moisture-permeable laminated film) possesses the excellent moisture permeability and waterproof, windproof properties of the component materials. Subsequent lamination of such a laminated sheet to another base material allows the same properties to be conferred to the base material with relative ease. In particular, when employed as an interlining for lamination with a garment face fabric, such a laminated sheet lends itself well to the manufacture of textile articles in small lots using a simple press within the textile processor's own facilities. Such interlinings, when laminated in garments, can confer the same properties to garments as well.

What is claimed is:

1. A laminated sheet comprising a laminate produced by bonding and laminating a nonwoven fabric with a nonporous waterproof and windproof moisture-permeable film.

2. The laminated sheet of claim 1, wherein the nonwoven fabric in the laminate has an adhesive layer dispersed and coated over substantially the entire surface thereof.

3. The laminated sheet of claim 1 or 2, wherein the laminate has a water vapor transmission rate, as measured by method A-1 described in section 4.1.1 of JIS L-1099, of 1,000 to 20,000 g/m²·24 h; an air permeability, as measured according to JIS L-1018, of up to 30 cm³/cm²/s; and a water pressure resistance, as measured according to JIS L-1092, of 100 to 40,000 mm.

4. A laminated sheet according to any one of claims 1 to 3, wherein the film is hydrophilic.

5. The laminated sheet according to any one of claims 1 to 4, wherein the film is made of a polyesterether elastomer.

6. The laminated sheet according to any one of claims 1 to 5, wherein the film is made of a polyesterether elastomer prepared by ester linkages between long-chain ester repeating units of formula (I) below and short-chain ester repeating units of formula (II) below, 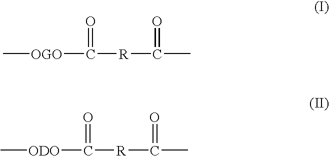
wherein:
a) G is a divalent radical remaining after the removal of terminal hydroxyl groups from a poly(alkylene oxide)glycol having a number average molecular weight of about 400-4000;
b) R is a divalent radical remaining after removal of carboxyl groups from a dicarboxylic acid having a molecular weight less than 300;
c) D is a divalent radical remaining after removal of hydroxyl groups from a diol having a molecular weight less than about 250; optionally
d) the copolyetherester contains 0-68 weight percent based on the total weight of the copolyetherester, ethylene oxide groups incorporated in the long-chain ester units of the copolyetherester; and
e) the copolyetherester contains about 25-80 weight percent short-chain ester units.

7. The laminated sheet of any one of claims 1 to 6, wherein the laminate is produced by bonding the nonwoven fabric and the film with a hot-melt adhesive.

8. The laminated sheet of any one of claims 5 to 7, wherein the nonwoven fabric is made with polyester fibers and the hot melt adhesive is composed primarily of a polyester resin.

9. An interlining which contains the laminated sheet of any one of claims 1 to 8.

10. A garment or fabric which uses the interlining of claim 9.
